(19) United States
(12) Patent Application Publication
(10) Pub. No.: US 2008/0291342 A1
(43) Pub. Date: Nov. 27, 2008

(54) Projection Type Video Display Apparatus

(75) Inventor: Shinichi HIRAI, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/124,007

(22) Filed: May 20, 2008

(30) Foreign Application Priority Data
May 21, 2007 (JP) 2007-134406

(51) Int. Cl. H04N 3/22

(52) U.S. Cl. 348/745; 348/E03.04

(57) ABSTRACT

Disclosed is a projection type video display apparatus including: a projection section to generate projection light of a video to output through a projection lens; an imaging section to image through a camera lens in a direction in which a video is projected; an XY driving section to change a projection direction of a video projected by the projection section; and a control section to perform a position adjustment processing of the projected video relative to a screen, wherein in the position adjustment processing, the control section allows the imaging section to image in the projection direction and when a plurality of pre-set marks are in an imaged image, the control section allows the XY driving section to drive so that a center point shown by the plurality of marks and a center point of the projected video overlap.

### BACKGROUND OF THE INVENTION

1. Field of the Invention

The present invention relates to a projection type video display apparatus to project a video.

2. Description of Related Art

As a projection type video display apparatus there is a projector apparatus which projects a video on a screen. In a projector apparatus, typically, registration of a projected video is performed by manually adjusting a direction and tilt of the apparatus so that the video is displayed at a desired position on the screen. A user adjusts focus of the projected video by appropriately changing a distance between an apparatus and a screen or by turning a knob to move a projection lens so that the projected video is focused.

A projector apparatus comprising a function which automatically measures the distance to the screen and automatically adjusts the focus by changing the position of the projection lens with an internal control processing according to the measured distance has also been developed.

The following techniques are disclosed as techniques related to the present invention. For example, Japanese Patent Application Laid-Open Publication No. 2006-098789 discloses a technique which pastes a plurality of points on a screen and images these points to correct the size and the like of the projected video according to the plurality of points. Japanese Patent Application Laid-Open Publication No. 2006-064913 discloses a technique which calculates a direction and distance of a screen by placing a plurality of marks on the screen and imaging this with an omnidirectional camera. Japanese Patent Application Laid-Open Publication No. 2003-015218 discloses a technique which projects a fiducial mark and performs a registration of two projected images according to this fiducial mark.

In a projector apparatus, it is complicated work for a user to manually perform registration of the projected video or manually adjust the focus of the projected video. In apparatuses which adjust the focus by automatically measuring the distance between the apparatus and the screen, there is a problem that type of screen is limited in order to accurately measure the distance.

### SUMMARY OF THE INVENTION

It is, therefore, a main object of the present invention to provide a projection type video display apparatus which can perform position adjustment or focus adjustment of a projected video in various situations such as being able to automatically adjust the position or the focus without causing trouble to the user and without limitation of type of screen.

According to a first aspect of the present invention, there is provided a projection type video display apparatus comprising:

a projection section to generate projection light of a video to output through a projection lens;

an imaging section to image through a camera lens in a direction in which a video is projected;

an XY driving section to change a projection direction of a video projected by the projection section; and

a control section to perform a position adjustment processing of the projected video relative to a screen, wherein

in the position adjustment processing, the control section allows the imaging section to image in the projection direction and when a plurality of pre-set marks are in an imaged image, the control section allows the XY driving section to drive so that a center point shown by the plurality of marks and a center point of the projected video overlap.

Preferably, in the projection type video display apparatus, the XY driving section moves the projection lens and the camera lens in a manner interlocked with each other; and

in the position adjustment processing, the control section calculates the center point shown by the plurality of marks on the imaged screen and the center point of the video projected by the projection section on the imaged screen and allows the XY driving section to move by only an amount of a difference between the points.

Preferably, the projection type video display apparatus further comprises a focus driving section to change positions of the projection lens and the camera lens in a manner interlocked with each other in a direction to change focus so that focus of the imaged image by the imaging section and focus of the projected video by the projection section is focused and unfocused in coordination with each other, wherein

the control section performs a focus adjustment processing of the projected video; and

in the focus adjustment processing, the control section allows the imaging section to image in the projection direction, and when a plurality of pre-set marks are in an imaged image, the control section analyzes the image imaged by the imaging section while allowing the focus driving section to move, and the control section allows the focus driving section to move the camera lens and the projection lens to a position where the projected video is focused at the center point shown by the plurality of marks based on a difference of an amount of unfocus of each mark.

Preferably, in the projection type video display apparatus, the plurality of marks include two marks positioned on a diagonal line of the screen with a center of the screen between the two marks; and

the control section determines a point which divides a line connecting the two marks in half to be the center point.

Preferably, in the projection type video display apparatus, the marks are a design with a bright portion and a dark portion positioned alternately.

According to a second aspect of the present invention, there is provided a projection type video display apparatus comprising:

a projection section to generate projection light of a video to output through a projection lens;

an imaging section to image through a camera lens in a direction in which a video is projected;

an XY driving section to change positions of the projection lens and the camera lens in a manner interlocked with each other in a direction to which a projection direction of a video is changed;

a focus driving section to change positions of the projection lens and the camera lens in a manner interlocked with each other in a direction to change focus; and

a control section to perform a position adjustment processing of the projected video relative to a screen and a focus adjustment processing of the projected video, wherein

in the position adjustment processing, the control section allows the imaging section to image in the projection direction and when two pre-set marks are imaged in an imaged image, the control section calculates a center point shown by the two marks on the imaged screen and a center point of the video projected by the projection section on the imaged screen and the control section allows the XY driving section to move by only an amount of a difference between the points; and

in the focus adjustment processing, the control section allows the imaging section to image in the projection direction, and when two pre-set marks are imaged in the imaged image, the control section analyzes the image imaged by the imaging section while allowing the focus driving section to move, and the control section allows the focus driving section to move the camera lens and the projection lens to a position where the projected video is focused at the center point shown by the two marks based on a difference of an amount of unfocus of each mark.

### BRIEF DESCRIPTION OF THE DRAWINGS

The above and other objects, advantages, and features of the present invention will become more fully understood from the detailed description given hereinbelow and the appended drawings which are given by way of illustration only, and thus are not intended as a definition of the limits of the present invention, and wherein:

FIG. 1 is a block diagram showing a structure of a projection type video display apparatus according to the present embodiment;

FIG. 2 is an elevation view showing one example of a mark pasted on a screen;

FIG. 3 is an explanatory diagram showing an analysis operation of a position adjustment processing of the projected video;

FIG. 4A to 4C are explanatory diagrams showing an operation of the position adjustment processing of the projected video;

FIG. 5A is an explanatory diagram showing an imaged image of a mark in front focus;

FIG. 5B is an explanatory diagram showing an imaged image of a mark in focus;

FIG. 5C is an explanatory diagram showing an imaged image of a mark in back focus;

FIG. 6 is a flowchart showing a procedure of image registration processing performed by the CPU; and

FIG. 7 is a flowchart showing a procedure of the focusing processing performed by the CPU.

### DESCRIPTION OF THE PREFERRED EMBODIMENTS

The best mode for carrying out the projection type video display apparatus according to the present invention will be explained in detail with reference to the drawings.

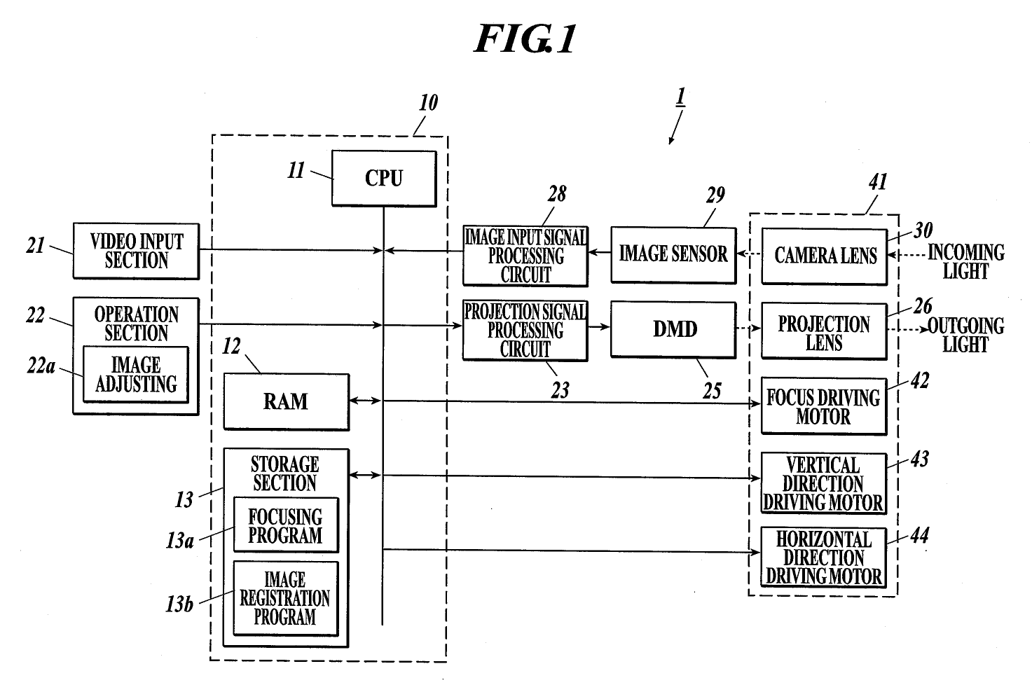

FIG. 1 is a block diagram showing a structure of a projection type video display apparatus according to the present embodiment.

The projection type video display apparatus 1 of the present embodiment is an apparatus which performs video display by projecting a light of a video on a screen. The projection type video display apparatus 1 comprises a video input section 21 for performing input processing of a video signal or video data sent from outside, an operation section 22 which includes a plurality of operation buttons for receiving input of an operation instruction from a user, a microcomputer 10 as a control section for generally controlling the apparatus, a Digital Micromirror Device (DMD) 25 as a projection section which reflects a lamp light with respect to each dot in a video to generate a projected light of the video, a signal processing circuit 23 which generates a projection video signal from the video data or the video signal to be supplied to the DMD 25, a projection lens 26 for projecting a reflected light of the DMD 25 onto the screen, a camera lens 30 for capturing the video projected on the screen, an image sensor 29 such as a Charge Coupled Device (CCD) as an imaging section for imaging the video captured by the camera lens 30, a signal processing circuit 28 for converting the image signal output from the image sensor 29 into data, an interlocking mechanism 41 for interlocking the camera lens 30 and the projection lens 26, a focus driving motor 42 as a focus driving section for driving the camera lens 30 and the projection lens 26 in a direction of focus, a vertical direction driving motor 43 and a horizontal direction driving motor 44 as an XY driving section for driving the camera lens 30 and the projection lens 26 so that the video moves left, right, up and down, and the like.

The microcomputer 10 is provided with a Central Processing Unit (CPU) 11 for performing a control program to control an operation of the apparatus, a Random Access Memory (RAM) 12 for providing memory space for the CPU 11 to work in, a storage section 13 such as a flash memory for storing control data and a control program, and the like. A focusing processing program 13a for focusing the projected video and a registration processing program 13b for adjusting the position of the projected video according to the screen are provided in the storage section 13.

The operation section 22 is provided with various operation keys and an operation key 22a for adjusting the focus or the position of the video.

The camera lens 30 and the projection lens 26 are lenses with depth of focus similar to each other. The interlocking mechanism 41 move the positions of the camera lens 30 and the projection lens 26 in a manner interlocked with each other. For example, when the distance to an object to be imaged and the distance to where a video is to be projected is the same, when the position of the camera lens 30 is moved so that the imaged image is in focus, the position of the projection lens 26 is moved similarly and the projected video becomes focused, whereas when the position of the camera lens 30 is changed so that the imaged image is unfocused, the position of the projection lens 26 is changed similarly and the projected video becomes unfocused. When the camera lens 30 changes the direction vertically and horizontally and the position of the object to be imaged is changed vertically and horizontally, the position of the projection lens 26 changes similarly and the center point of the projected video changes vertically and horizontally. Specifically, the above-described interlocking mechanism 41 allows the center point of the imaged image and the center point of the projected video (maximum resolution) to be constantly overlapped.

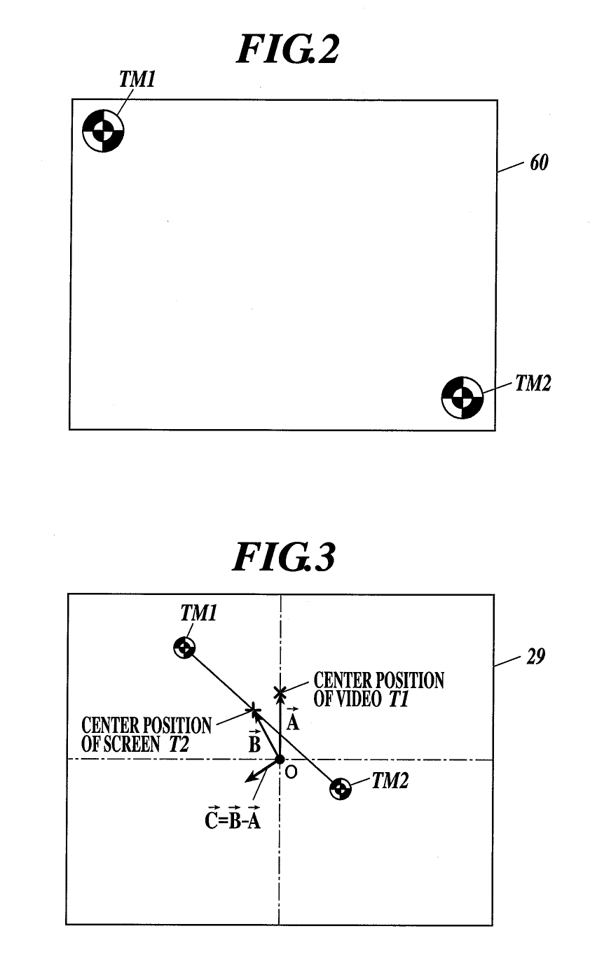

FIG. 2 is an elevation view showing one example of a mark pasted on a screen.

Two predetermined registration marks TM1 and TM2 are pasted on a screen 60 where a video is projected. The locations to be pasted are two locations, the upper edge and the lower edge on a diagonal line of the screen with the center of the screen between the two marks. The registration marks TM1 and TM2 are set as round marks in which white portions (bright portion) and black portions (dark portion) are alternately placed. The white portions and the black portions are alternately placed in each area where the central angle of the circle is divided in a plurality of portions (quadrisection) and the radius of the circle is divided in a plurality of portions (approximately bisection) and the total area of the white portions and the total area of the black portions are the same.

According to the projection type video display apparatus 1 with the above-described structure, the video is projected on the screen with the following process. In other words, when video data or a video signal is input from outside through the video input section 21, the video data or video signal is sent to the signal processing circuit 23 and a projection video signal is output from the signal processing circuit 23 and supplied to the DMD 25. Then, a lamp light (not shown) is reflected by the DMD 25 and output through the projection lens 26. This light is projected on the screen 60 to display a video.

When the user operates the image registration operation key 22a, the processing of registration and focusing of the projected video is performed with the following process. The processing does not need to start based on the operation of the operation key 22a and may start based on various situations such as starting automatically when power is turned on or when a video is output, starting when the projection type video display apparatus 1 is moved while power is on, or starting with respect to each predetermined time during output of a video.

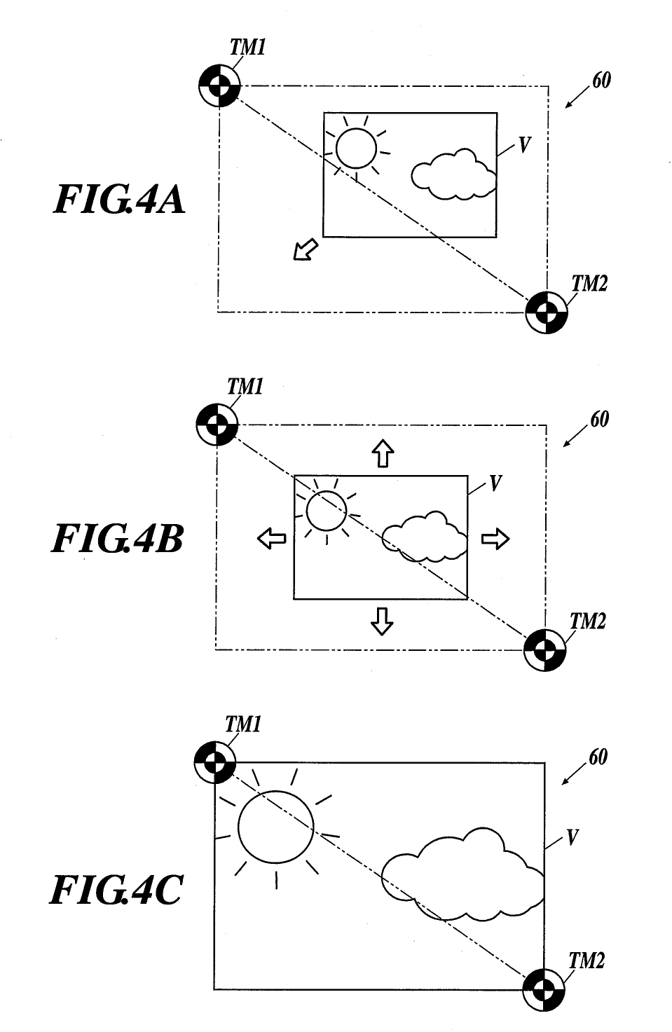

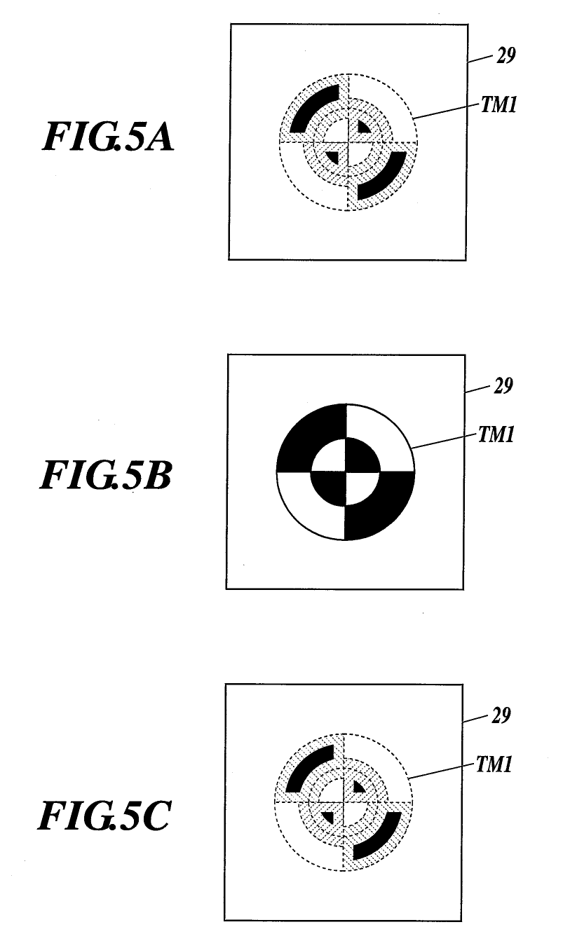

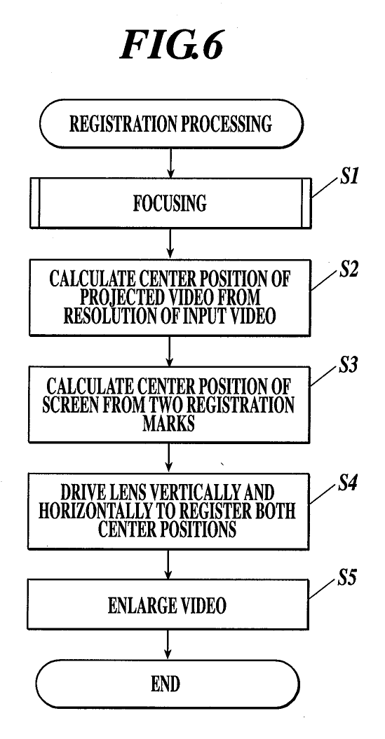

FIG. 3 is an explanatory diagram showing an analysis operation of a position adjustment processing of the projected video and FIG. 4A to FIG. 4C are explanatory diagrams showing an operation of the position adjustment processing of the projected video. FIG. 6 is a flowchart showing registration processing of the projected video performed by the CPU.

When the registration processing starts, first, the focusing processing is performed so that a projected video is focused at the center of screen 60 (FIG. 6: step S1). This focusing processing will be described later. After the focusing ends, next the center position T1 of the projected video is calculated from the information of the resolution of the video input from outside (step S2).

As described above, the positions of the camera lens 30 and the projection lens 26 are changed in a manner interlocked with each other so that a center point O of the image imaged by the image sensor 29 (see FIG. 3) and the center position T1 of the projected video are set to constantly overlap when the video is at maximum resolution. When a video is projected at a different resolution, the center position T1 of the projected video and the center point O of the imaged image may be out of alignment according to the resolution of the video, and the amount of misalignment is determined depending on the resolution of the video. For example, as shown in FIG. 3, in a video with a resolution whose aspect ratio is longer in width, the center position T1 of the projected video may be misaligned above the center point O of the imaged image. The amount and direction of the misalignment of the center position according to resolution depends on which area of the DMD 25 is used to output the video of the low resolution video signal, thus the misalignment is not limited to that shown in FIG. 3 and various forms may be possible.

After the center position T1 of the projected video is calculated, as shown in FIG. 3, the image sensor 29 images an area in front of the apparatus to capture it as image data and calculates the center position T2 of the screen 60 from the two registration marks TM1 and TM2 in the image data (step S3). In this embodiment, a center point of a line connecting the two registration marks TM1 and TM2 is recognized as the center position T2 of the screen 60.

Next, the difference (vector C shown in FIG. 3) between both center positions T2 and T1 is calculated and the vertical direction driving motor 43 and the horizontal direction driving motor 44 are driven to move the positions of the camera lens 30 and the projection lens 26 by only the amount of the difference so that the center position T1 of the projected video and the center position T2 of the screen 60 overlap (step S4). For example, as shown in FIG. 4A to FIG. 4B, the projected video V output through the projection lens 26 is moved on the screen 60 so that the center position of the projected video V overlaps with the center position of the registration marks TM1 and TM2.

The structure is not limited, thus when the projection type video display apparatus 1 comprises a zoom lens, as shown in FIG. 4B to FIG. 4C, the zoom lens may be automatically driven so that the projected video is enlarged to an area enclosed by the registration marks TM1 and TM2 (step S5).

According to the above-described registration processing, a user only needs to position the projection type video display apparatus 1 roughly facing the screen 60 and operate the image registration operation key 22a to allow the projection type video display apparatus 1 to automatically perform registration of the projected video to the center of the screen 60.

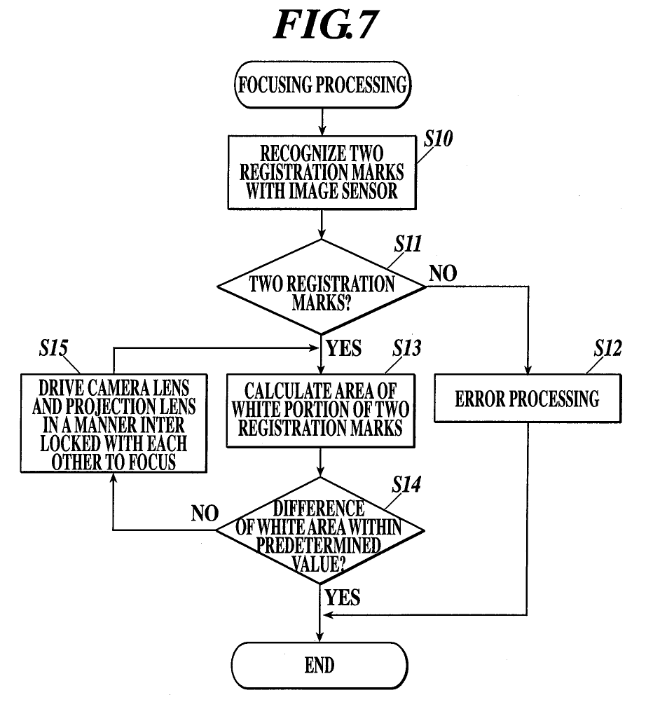

FIG. 5A is an explanatory diagram showing an imaged image of the registration mark TM1 in front focus, FIG. 5B is an explanatory diagram showing an imaged image of the registration mark TM1 in focus, FIG. 5C is an explanatory diagram showing an imaged image of the registration mark TM1 in back focus and FIG. 7 is a flowchart showing the focusing processing performed by the CPU.

In step S1 of the above-described registration processing (FIG. 6), the following focusing processing is performed. When the processing advances to the focusing processing, first the image sensor 29 captures the image data and the image recognizing processing is performed to search for the two registration marks TM1 and TM2 in the imaged image (FIG. 7: step S10). Here, the registration marks TM1 and TM2 imaged by the image sensor 29 may be out of focus or in focus. However, for example, by storing in advance in the storage section 13 imaged data of the registration marks TM1 and TM2 in a focused state and imaged data of the registration marks TM1 and TM2 in an unfocused state, and searching for a portion close to the imaged data in the image data of the imaged image, the registration marks TM1 and TM2 may be relatively easily recognized either in a focused or unfocused state.

When certain image recognition is performed, branching processing of whether or not the two registration marks TM1 and TM2 were found (step S11) is performed, and when the two registration marks TM1 and TM2 are not found, error processing S12 is performed and the focusing processing ends, whereas when the two registration marks TM1 and TM2 are found, the area of the white portions of the two registration marks TM1 and TM2 are calculated (step S13).

As shown in FIG. 5A to FIG. 5C, the area ratio of the white portions and the black portions of the mark image TM1 (and TM2) input in the image sensor 29 are different between when the image is in focus (FIG. 5B) and when the image is unfocused due to the camera lens 30 being too forward (FIG. 5A) or too rear (FIG. 5C). In other words, when the image is in focus, the area ratio of the white portions and the black portions is approximately 50:50, whereas when the image is out of focus the projected light representing white blurs into the black portion and this portion becomes a slightly darkened white. By calculating the area as considering the slightly darkened white portions to be white, the area ratio of the white portion becomes large.

Typically, the projection type video display apparatus 1 is placed in a lower position relative to the screen 60 and the screen 60 is placed so that the projection surface is vertical. Thus, the length between the camera lens 30 and the upper registration mark TM1 is different from that between the camera lens 30 and the lower registration mark TM2. In other words, as for the lengths between the camera lens 30 and the registration marks TM1 and TM2, the length between the camera lens 30 and the upper registration mark TM1 becomes longer. Thus, when the focus driving motor 42 is driven to position the camera lens 30 so that the upper registration mark TM1 is focused, the portion of the lower registration mark TM2 becomes unfocused, and the area of the white portions of the registration mark TM2 on the imaged image becomes relatively large. When the lower registration mark TM2 is focused, the portion of the upper registration mark TM1 becomes unfocused, and the area of the white portions of the registration mark TM1 on the imaged image becomes relatively large.

Thus, when the position of the camera lens 30 is changed to the intermediate position between the positions where the upper registration mark TM1 is focused and the lower registration mark TM2 is focused, it is focused to the center of the screen 60. Here, since the upper registration mark TM1 is positioned to be relatively back focus and the lower registration mark TM2 is positioned to be relatively front focus, though the directions of misalignment are each different being to the front or to the back, both registration marks TM1 and TM2 are unfocused in a same amount, thus the areas of the white portions of both registration marks TM1 and TM2 on the imaged image should be the same value.

After the areas of the white portions of the two registration marks TM1 and TM2 are calculated as described above (step S13), the difference of the area of the white areas of the two marks are calculated to determine whether or not the value is within a predetermined value (step S14). When the value is within a predetermined value, it is determined that it is focused to the center position of the screen 60 and the focusing processing ends, whereas when the value is not within a predetermined value, it is determined that it is unfocused to the center position of the screen 60 and the positions of the camera lens 30 and the projection lens 26 are changed in a manner interlocked with each other in the direction of focus (step S15). Then the processing is repeated again from the process of calculating the areas of the white portions of the registration marks TM1 and TM2. By repeating the processing of steps S13 to S15, the processing of finding the position of focus may be possible by for example, by moving the camera lens 30 and the projection lens 26 by small amounts from the rear to the front until a position of focus is found, or when the difference of the white areas become smaller, by gradually moving the position of the lenses in the same direction, whereas when the areas of the white portions become larger, by changing the driving direction of the lenses.

According to the above-described focusing processing, the camera lens 30 is focused to the center of the screen 60 and the interlocking mechanism 41 changes the positions of the camera lens 30 and the projection lens 26 in a manner interlocked with each other so that the focused positions overlap. Thus, the video projected through the projection lens 26 is also focused in the center of the screen 60.

In the above-described focusing processing, the areas of the white portions of the upper and lower registration marks TM1 and TM2 are compared and it is determined that the center of the screen 60 is focused when the areas are almost the same. However, other various methods of determining whether or not the center of the screen is focused may be used. For example, the above-described registration marks TM1 and TM2 may be determined to be focused when the area of the white portion and the area of the black portion on the imaged image is approximately 50:50, thus by detecting the positions of the camera lens 30 when the registration marks TM1 and TM2 are each in focus and changing the position of the camera lens 30 to an intermediate position in between the positions of where the marks are focused, the center of the screen 60 may be focused.

As described above, according to the projection type video display apparatus 1 of the present embodiment, by pasting two registration marks TM1 and TM2 on a diagonal line of the screen with the center of the screen 60 between the two marks, automatic registration so that the projected video is placed in the center or automatic focus adjustment so that the center of the projected video is focused may be performed without causing trouble to the user.

The camera lens 30 and the projection lens 26 are moved in a manner interlocked with each other. Consequently, an advantage of being able to perform registration and focusing of the projected video even when the video is not actually projected may be obtained.

The registration marks TM1 and TM2 pasted on the screen 60 are set as a predetermined design, thus the mark may be easily found in the image recognizing processing. The registration marks TM1 and TM2 are a design in which the bright portions and the dark portions are positioned alternately, thus it is easy to confirm how much the image is out of focus by the image analyzing and processing.

The present invention is not limited to the above-described embodiments and various modifications may be made. For example, a round registration mark is shown as an example of a mark image, however, the mark image may be, for example, a mark with rectangular bright portions and dark portions positioned alternately. Other various marks may be used. The position and the number of the mark provided on the screen is not limited to the pattern in the above-described embodiment and various modifications may be made, for example, four marks provided in four corners or two marks provided in the upper center and the lower center.

In the above-described embodiment, an example which uses a DMD as a method of video projection is shown, however the method of video projection used is not limited and a method which uses, for example, reflective liquid crystal elements may be used. An example which moves the position of the camera lens 30 itself and the projection lens 26 itself in order to adjust the focus and to move the projected video is shown, however, a mechanism for moving the projection type video display apparatus 1 itself forward and backward or changing the angle of tilting of the projection type video display apparatus 1 itself may be provided to change the relative position of the projection lens and the screen so that the projected video is focused or the position of the projected video is moved.

Other details of the structure and the processing shown in the present embodiment may be modified without leaving the spirit of the invention.

According to a first aspect of the preferred embodiments, there is provided a projection type video display apparatus comprising:

a projection section to generate projection light of a video to output through a projection lens;

an imaging section to image through a camera lens in a direction in which a video is projected;

an XY driving section to change a projection direction of a video projected by the projection section; and

a control section to perform a position adjustment processing of the projected video relative to a screen, wherein

in the position adjustment processing, the control section allows the imaging section to image in the projection direction and when a plurality of pre-set marks are in an imaged image, the control section allows the XY driving section to drive so that a center point shown by the plurality of marks and a center point of the projected video overlap.

Preferably, in the projection type video display apparatus, the XY driving section moves the projection lens and the camera lens in a manner interlocked with each other; and

in the position adjustment processing, the control section calculates the center point shown by the plurality of marks on the imaged screen and the center point of the video projected by the projection section on the imaged screen and allows the XY driving section to move by only an amount of a difference between the points.

Preferably, the projection type video display apparatus further comprises a focus driving section to change positions of the projection lens and the camera lens in a manner interlocked with each other in a direction to change focus so that focus of the imaged image by the imaging section and focus of the projected video by the projection section is focused and unfocused in coordination with each other, wherein

the control section performs a focus adjustment processing of the projected video; and

in the focus adjustment processing, the control section allows the imaging section to image in the projection direction, and when a plurality of pre-set marks are in an imaged image, the control section analyzes the image imaged by the imaging section while allowing the focus driving section to move, and the control section allows the focus driving section to move the camera lens and the projection lens to a position where the projected video is focused at the center point shown by the plurality of marks based on a difference of an amount of unfocus of each mark.

Preferably, in the projection type video display apparatus, the plurality of marks include two marks positioned on a diagonal line of the screen with a center of the screen between the two marks; and

the control section determines a point which divides a line connecting the two marks in half to be the center point.

Preferably, in the projection type video display apparatus, the marks are a design with a bright portion and a dark portion positioned alternately.

According to a second aspect of the preferred embodiments, there is provided a projection type video display apparatus comprising:

a projection section to generate projection light of a video to output through a projection lens;

an imaging section to image through a camera lens in a direction in which a video is projected;

an XY driving section to change positions of the projection lens and the camera lens in a manner interlocked with each other in a direction to which a projection direction of a video is changed;

a focus driving section to change positions of the projection lens and the camera lens in a manner interlocked with each other in a direction to change focus; and

a control section to perform a position adjustment processing of the projected video relative to a screen and a focus adjustment processing of the projected video, wherein

in the position adjustment processing, the control section allows the imaging section to image in the projection direction and when two pre-set marks are imaged in an imaged image, the control section calculates a center point shown by the two marks on the imaged screen and a center point of the video projected by the projection section on the imaged screen and the control section allows the XY driving section to move by only an amount of a difference between the points; and

in the focus adjustment processing, the control section allows the imaging section to image in the projection direction, and when two pre-set marks are imaged in the imaged image, the control section analyzes the image imaged by the imaging section while allowing the focus driving section to move, and the control section allows the focus driving section to move the camera lens and the projection lens to a position where the projected video is focused at the center point shown by the two marks based on a difference of an amount of unfocus of each mark.

According to these aspects, by pasting a plurality of marks in suitable positions on the screen, an advantage of automatically performing the registration of the video so that the projected video is in the center position may be obtained.

The entire disclosure of Japanese Patent Application No. 2007-134406 filed on May 21, 2007 including description, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A projection type video display apparatus comprising:
a projection section to generate projection light of a video to output through a projection lens;
an imaging section to image through a camera lens in a direction in which a video is projected;
an XY driving section to change a projection direction of a video projected by the projection section; and
a control section to perform a position adjustment processing of the projected video relative to a screen, wherein
in the position adjustment processing, the control section allows the imaging section to image in the projection direction and when a plurality of pre-set marks are in an imaged image, the control section allows the XY driving section to drive so that a center point shown by the plurality of marks and a center point of the projected video overlap.

2. The projection type video display apparatus according to claim 1, wherein the XY driving section moves the projection lens and the camera lens in a manner interlocked with each other; and
in the position adjustment processing, the control section calculates the center point shown by the plurality of marks on the imaged screen and the center point of the video projected by the projection section on the imaged screen and allows the XY driving section to move by only an amount of a difference between the points.

3. The projection type video display apparatus according to claim 1, further comprising a focus driving section to change positions of the projection lens and the camera lens in a manner interlocked with each other in a direction to change focus so that focus of the imaged image by the imaging section and focus of the projected video by the projection section is focused and unfocused in coordination with each other, wherein
the control section performs a focus adjustment processing of the projected video; and
in the focus adjustment processing, the control section allows the imaging section to image in the projection direction, and when a plurality of pre-set marks are in an imaged image, the control section analyzes the image imaged by the imaging section while allowing the focus driving section to move, and the control section allows the focus driving section to move the camera lens and the projection lens to a position where the projected video is focused at the center point shown by the plurality of marks based on a difference of an amount of unfocus of each mark.

4. The projection type video display apparatus according to claim 1, wherein the plurality of marks include two marks positioned on a diagonal line of the screen with a center of the screen between the two marks; and
the control section determines a point which divides a line connecting the two marks in half to be the center point.

5. The projection type video display apparatus according to claim 1, wherein the marks are a design with a bright portion and a dark portion positioned alternately.

6. A projection type video display apparatus comprising:
a projection section to generate projection light of a video to output through a projection lens;
an imaging section to image through a camera lens in a direction in which a video is projected;
an XY driving section to change positions of the projection lens and the camera lens in a manner interlocked with each other in a direction to which a projection direction of a video is changed;
a focus driving section to change positions of the projection lens and the camera lens in a manner interlocked with each other in a direction to change focus; and
a control section to perform a position adjustment processing of the projected video relative to a screen and a focus adjustment processing of the projected video, wherein
in the position adjustment processing, the control section allows the imaging section to image in the projection direction and when two pre-set marks are imaged in an imaged image, the control section calculates a center point shown by the two marks on the imaged screen and a center point of the video projected by the projection section on the imaged screen and the control section allows the XY driving section to move by only an amount of a difference between the points; and
in the focus adjustment processing, the control section allows the imaging section to image in the projection direction, and when two pre-set marks are imaged in the imaged image, the control section analyzes the image imaged by the imaging section while allowing the focus driving section to move, and the control section allows the focus driving section to move the camera lens and the projection lens to a position where the projected video is focused at the center point shown by the two marks based on a difference of an amount of unfocus of each mark.
